(19) United States
(12) Patent Application Publication
(10) Pub. No.: US 2015/0336104 A1
(43) Pub. Date: Nov. 26, 2015

(54) COOLED GRINDER HEAD

(71) Applicant: JEFFREY W. PALESE, NORTH RIDGEVILLE, OH (US)

(72) Inventor: JEFFREY W. PALESE, NORTH RIDGEVILLE, OH (US)

(21) Appl. No.: 14/686,448

(22) Filed: Apr. 14, 2015

Related U.S. Application Data
(60) Provisional application No. 61/979,212, filed on Apr. 14, 2014.

(51) Int. Cl. B02C 18/30; F25D 5/02

(52) U.S. Cl. CPC B02C 18/305; F25D 5/02; B02C 2018/307

(57) ABSTRACT

An apparatus for cooling a grinder head includes a cooling pack adapted to be connected to an outer surface of a housing of the grinder head to cool the grinder head housing.

### RELATED APPLICATION

This application claims the benefit of U.S. Provisional Application Ser. No. 61/979,212, filed on Apr. 14, 2014, the disclosure of which is hereby incorporated by reference in its entirety.

### TECHNICAL FIELD

This invention relates to a food processing apparatus, More specifically, this invention relates to a cooled grinder head adapted to receive a coolant that helps maintain the head in a cooled condition during use.

### BACKGROUND OF THE INVENTION

Grinders are food processing appliances that are used to grind, chop or mince food products, such as meat, fish, poultry, vegetables, or similar foods. The most common food products processed in a grinder are meat products, such as beef, pork, venison, etc. During operation, the temperature inside the grinder head increases due to friction in the components and with the food products being processed. When grinding meat, this increased temperature inside the grinder head can cause the meat to heat up stick to the grinder components, which can slow down or block the grinding operation.

### SUMMARY OF THE INVENTION

According to one aspect, an apparatus for grinding food products includes a housing including an inlet for receiving food products to be ground, an outlet for discharging the ground food product, and a grinding portion for housing components operable to grind the food product. The apparatus also includes a cooling pack adapted to be connected to an outside surface of the housing to cool the grinding portion.

According to another aspect, the grinding portion has a generally cylindrical outside configuration that the cooling pack is configured to follow.

According to another aspect, the housing includes one or more tabs, and the cooling pack comprises one or more slots for receiving the tabs to thereby connect the cooling pack to the housing.

According to another aspect, the cooling pack extends circumferentially about 180 degrees around the grinding portion.

According to another aspect, an apparatus for cooling a grinder head includes a cooling pack adapted to be connected to an outer surface of a housing of the grinder head to cool the grinder head housing.

According to another aspect, the cooling pack can have a cylindrical configuration that mates with the cylindrical outer surface of the grinder head housing.

According to another aspect, the cooling pack can extend circumferentially greater than 180 degrees around the grinder head housing.

According to another aspect, the cooling pack can have a freezable and re-freezable construction.

According to another aspect, the cooling pack can include a first cooling pack half that has a cylindrical inner surface, and a second cooling pack half that has a cylindrical inner surface, the first and second cooling packs being connected to each other.

According to another aspect, the apparatus can include a first strap that connects a first end of the first cooling pack half to a first end of the second cooling pack half, the first strap being constructed and arranged to permit the first and second cooling pack halves to move relative to each other. The apparatus can also include a second strap that connects a second end of the first cooling pack half to a second end of the second cooling pack half, the second strap being releasable connectable with at least one of the first and second cooling pack halves.

According to another aspect, the first strap can permit the first and second cooling pack halves to move to an open condition in which the grinder head housing can be positioned between the halves, and wherein the second strap when connected to both cooling pack halves draws the halves together to connect the cooling pack to the grinder head housing.

According to another aspect, at least one of the first and second straps can have an elastomeric construction that applies a force to the cooling pack halves that draws the halves into mating engagement with the outer surface of the grinder head housing.

According to another aspect, at least one of the first and second straps can connect with at least one of the first and second cooling pack halves via an opening in the strap that deforms elastically to receive a tab on the cooling pack, the opening forming an interference with the tab that connects the strap to the cooling pack half.

According to another aspect, the first and second cooling pack halves can include gel-filled cooling packs.

According to another aspect, a grinder head housing cooling apparatus includes first and second cooling pack halves filled with a freezable and re-freezable substance, and at least one connector for connecting the cooling pack halves to each other and to the outer surface of the grinder head housing to cool the grinder head housing through thermal heat transfer.

According to another aspect, each of the cooling pack halves can have a cylindrical configuration that mates with the cylindrical outer surface of the grinder head housing.

According to another aspect, each cooling pack half can extend circumferentially less than 180 degrees around the grinder head housing, and wherein the cooling pack halves together extend circumferentially greater than 180 degrees around the grinder head housing.

According to another aspect, the first cooling pack half can have a cylindrical inner surface, and the second cooling pack half has a cylindrical inner surface.

According to another aspect, the apparatus can also include a first strap that connects a first end of the first cooling pack half to a first end of the second cooling pack half, the first strap being constructed and arranged to permit the first and second cooling pack halves to move relative to each other. The apparatus can also include a second strap that connects a second end of the first cooling pack half to a second end of the second, cooling pack half, the second strap being releasable connectable with at least one of the first and second cooling pack halves.

According to another aspect, the first strap can permit the first and second, cooling pack halves to move to an open condition in which the grinder head housing can be positioned between the halves, and wherein the second strap when connected to both cooling pack halves draws the halves together to connect the cooling pack to the grinder head housing.

According to another aspect, at least one of the first and second straps can have an elastomeric construction that applies a force to the cooling pack halves that draws the halves into mating engagement with the outer surface of the grinder head housing.

According to another aspect, at least one of the first and second straps can connect with at least one of the first and second cooling pack halves via an opening in the strap that deforms elastically to receive a tab on the cooling pack, the opening forming an interference with the tab that connects the strap to the cooling pack half.

According to another aspect, the first and second cooling pack halves can include gel-filled cooling packs.

### BRIEF DESCRIPTION OF THE DRAWINGS

For a better understanding of the invention, reference may be made to the accompanying drawings.

FIG. 1 is a perspective view illustrating a grinder including a grinder head according to an embodiment of the invention.

FIG. 2 is a partially exploded perspective view of the grinder of FIG. 1.

FIG. 3 is a side elevation view illustrating the assembly of a portion of the grinder of FIG. 1.

FIGS. 4 and 4A are side elevation and magnified detail views, respectively, illustrating the assembly of a portion of the grinder of FIG. 1.

FIGS. 5 and 5A are side elevation and magnified detail views, respectively, illustrating the assembly of a portion of the grinder of FIG. 1.

FIG. 6 is a perspective view illustrating an apparatus for cooling a grinder head, according to another embodiment of the invention.

FIG. 7 is a side elevation view of the apparatus of FIG. 6.

FIG. 8 is a bottom view of the apparatus of FIG. 6.

FIG. 9 is a front elevation view of the apparatus of FIG. 6.

FIG. 10 is a top view of the apparatus of FIG. 6.

FIG. 11 is a perspective view illustrating the installation of the apparatus of FIG. 6 on a grinder head.

FIGS. 12 and 13 are perspective views illustrating the apparatus installed on the grinder head.

FIG. 13A is a section view taken generally along line 13A-13A in FIG. 13.

FIG. 14 is a side elevation view of the apparatus of FIGS. 12 and 13.

FIG. 15 is a front elevation view of the apparatus of FIGS. 12 and 13.

### DESCRIPTION OF EMBODIMENTS

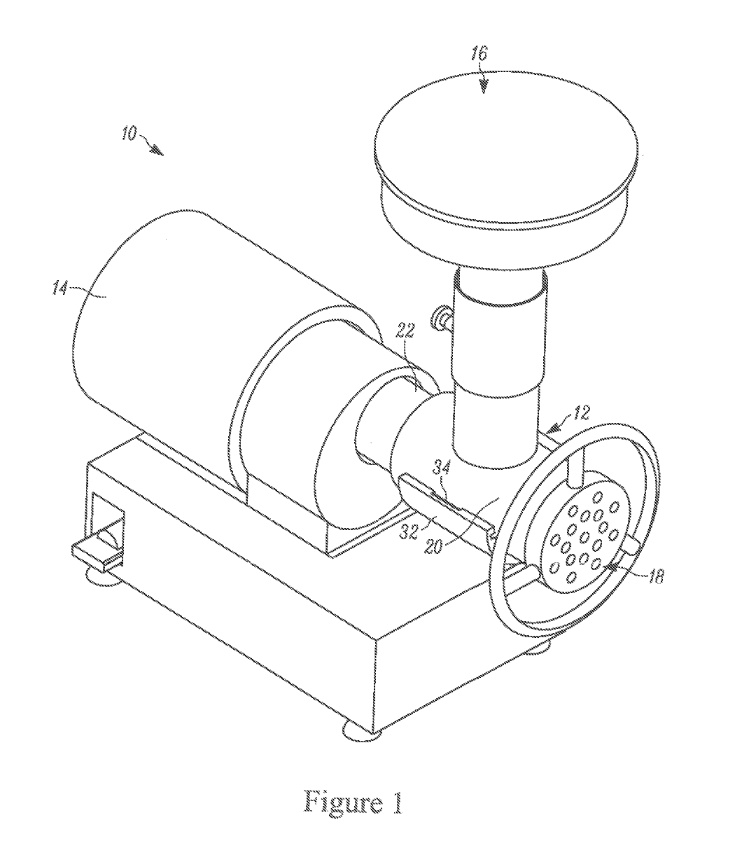

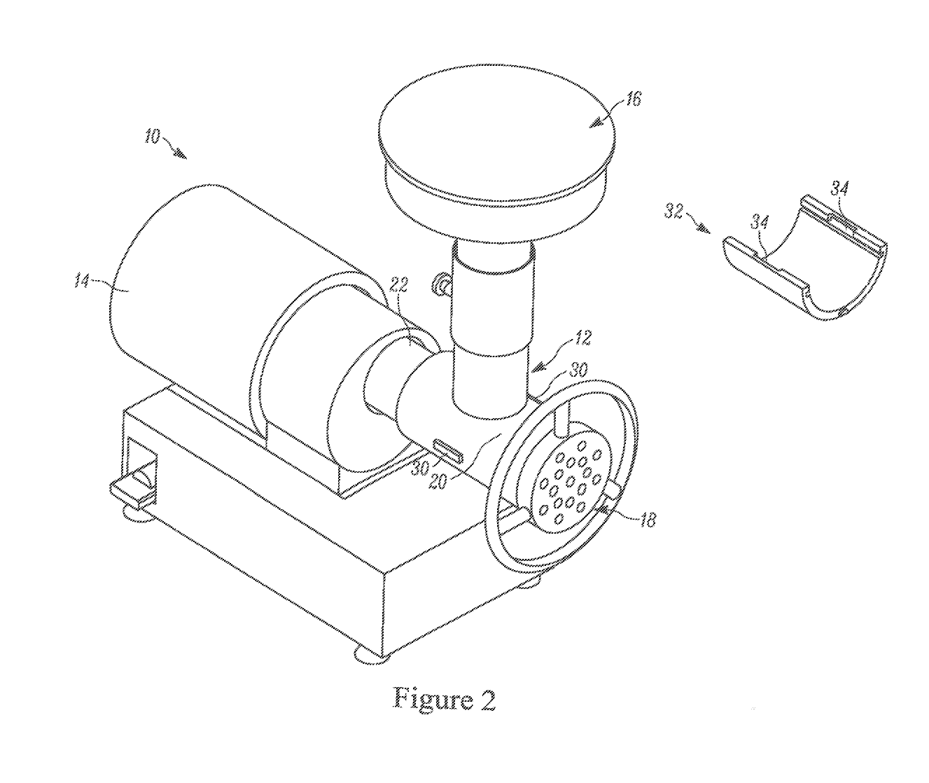

A known food processing apparatus 10 in the form of a meat grinder is illustrated in FIGS. 1 and 2. The meat grinder 10 includes a grinder head 12 and a power source 14, such as an electric motor. The electric motor power source could be replaced with a hand crank. The grinder head 12 includes an inlet or chute 16, into which raw meat is fed, and an outlet 18 from which the ground or minced meat is discharged. The grinder head 12 includes a housing 20 that houses typical grinder components, such as an auger/screw conveyor, a rotating knife including mincing blades, and a fixed hole plate or die. These typical components are shown, for example, in U.S. Pat. No. 7,207,510 B2, issued Apr. 24, 2007, the disclosure of which is hereby incorporated by reference in its entirety. A collar 22 attaches to the housing 20 to contain the grinder components therein. The collar 22 is removable from the housing for cleaning and for replacing/swapping components.

Whole or cubed raw meat is fed into the inlet 16 on top of the grinder head, and the meat is propelled horizontally on the rotating screw conveyor, which can also squash and partially mix the meat as it is propelled. At the end of the screw conveyor, the knife is positioned in front of and adjacent to the fixed hole plate. The screw conveyor forces the meat past the knife and through the plate. The rotating knife blades mince or grind the meat, which is discharged through the holes in the plate and through the outlet 18. The size of the holes in the plate determines the fineness of the ground meat.

According to a first embodiment of the invention, the meat grinder 10 includes a cooling feature that counteracts heating due to friction between internal components. This helps prevent the meat from heating up as it is ground, which can cause the ground meat to stick to the grinder components and inhibit or halt the grinding process, The cooling feature can have a variety of configurations.

In the illustrated embodiment, the housing 20 includes a pair of tabs 30 that serve to support a cooling pack 32. The cooling pack 32 has a generally semi cylindrical configuration that mates with a lower portion of the grinder housing 20. The cooling pack 32 includes a pair of slots 34 that are spaced and configured to receive the tabs 30. The tabs 30 cooperate with the slots 34 to support the cooling pack 32 on the housing 20. In the illustrated embodiment, the cooling pack 32 extends circumferentially around about half of, i.e., about 180 degrees around, the housing 20. The extent to which the cooling pack 32 extends circumferentially around the housing 20 can vary.

The cooling pack 32 can be filled with a coolant, such a liquid/gel-type substance commonly found in freezer chilled cooling packs. These gel in the gel packs are primarily water-based and include a gel-forming substance, such as hydroxyethyl cellulose or a vinyl-coated silica gel. Other materials can be added to prevent bacterial growth. Advantageously, the substance in such gel packs can formulated to have a freezing point below that of water (32° F.) and therefore can enhance the cooling of the grinder head 12.

The cooling pack 32 can have a variety of constructions. For example, the cooling pack 32 can be formed of plastic, metal, or a combination of plastic and metal. In one example construction, the cooling pack 32 can have a plastic portion that defies the coolant containing portion of the pack, and a metal portion fixed to the outside of the plastic portion to provide a metallic appearance. The metal portion can also lend strength and durability to the cooling pack 32, especially to the slots 34 that receives the tabs 30. This can be advantageous in that the metal or metal portions of the acts 34 can provide increased durability in comparison with plastic.

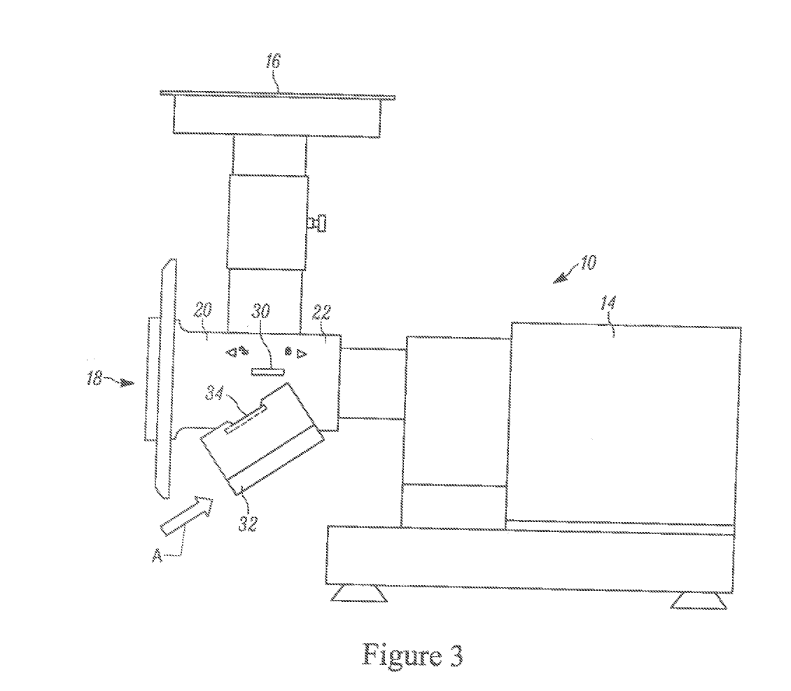

Installation of the cooling pack 32 on the grinder head 12 is illustrated in FIGS. 3-5. Referring to FIG. 3, the cooling pack 32 is maneuvered beneath the grinder head 12 so that the concave portion of the pack faces the corresponding portion of the housing 20. The cooling pack 32 is maneuvered in the direction indicated generally by the arrow A in FIG. 3.

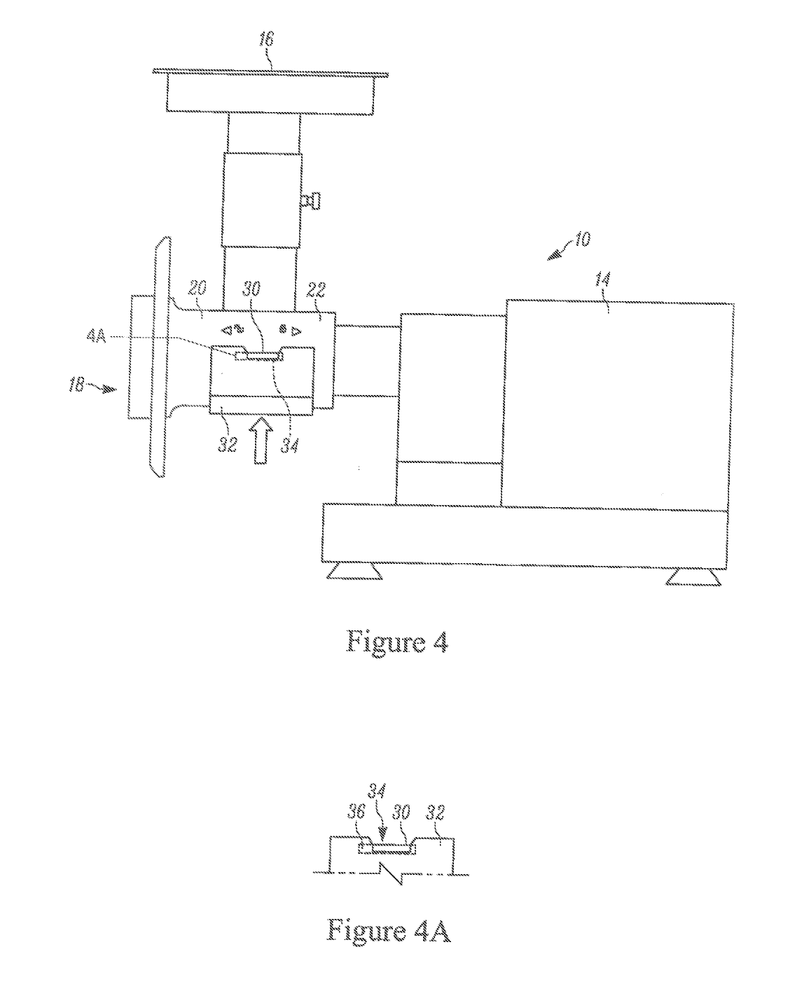

Once positioned appropriately relative to the grinder head 12, the cooling pack 32 is maneuvered onto the housing 20, as indicated generally by the arrow B FIG. 4. When this occurs, the tabs 30 enter their corresponding slots 34 on the cooling pack 32. This can be seen in the detail portion of FIG. 4.

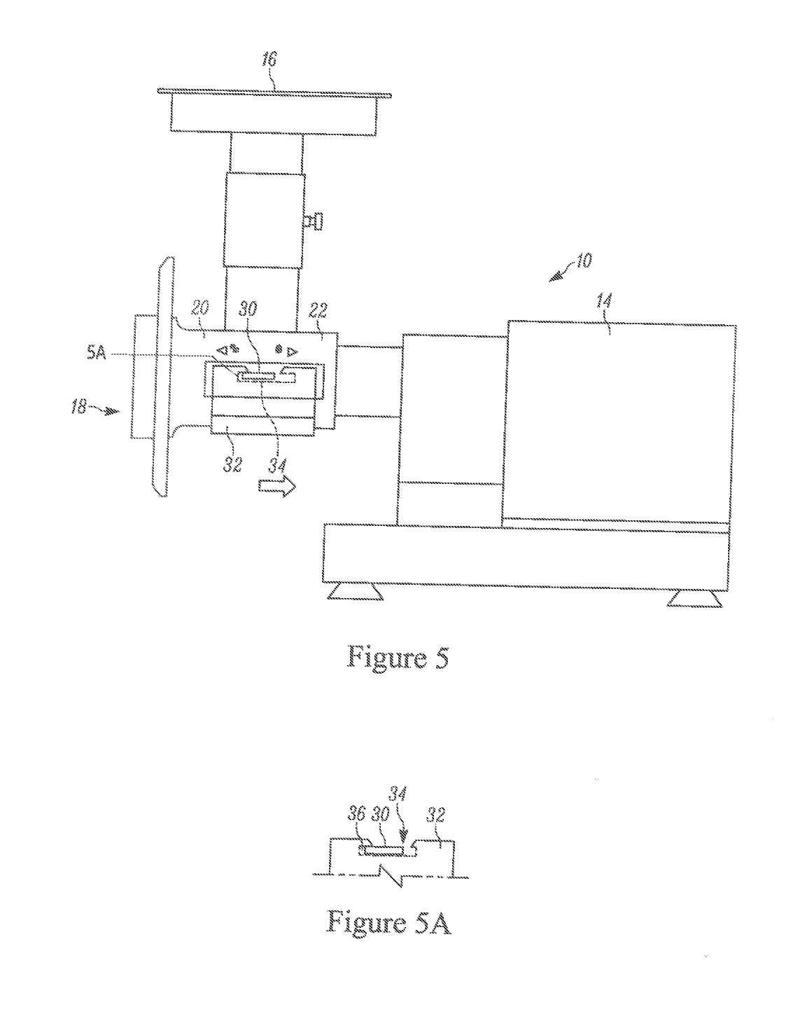

Next, the cooling pack 32 is slid in the direction indicated generally by the arrow C in FIG. 5, so that the tabs 30 enter the closed end 36 of the slot 34. The closed end 36 of the slot 34 retains the cooling pack 32 on the housing 20 of the grinder head 12. This is shown in the detail portion of FIG. 5. To effectuate the retention of the cooling pack 32 on the housing 20, the tabs 30 and the slots 34 may be designed to create an interference fit between the tabs and the closed end 36 of the slots. This fit would help prevent rattling and dislodgement of the cooling pack 32 from the grinder head 12 during use.

Advantageously, the removable cooling pack 32 allows for the use of multiple cooling packs in an interchangeable fashion. When the cooling packs 32 heat up during use and lose their effectiveness, they can be swapped with frozen standby packs, thus eliminating the need to halt the grinding process for a prolonged period.

During use, the cooling packs 32 help to maintain the grinder head 12 at a low temperature. For example, the coolant in the packs 32 can maintain the grinder head 12 at about 40° F. or less. The advantage of a coolant/gel-filled cooling pack 32 is that the gel can be formulated for cooling below 32° F.

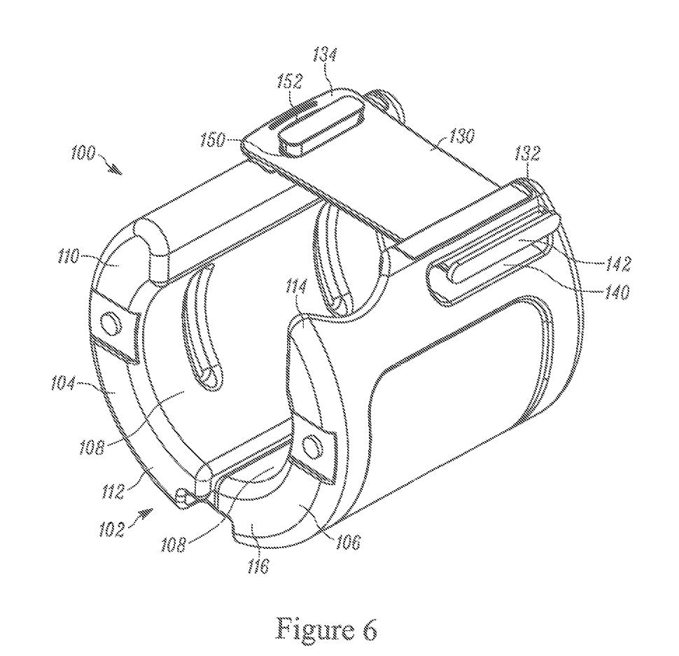

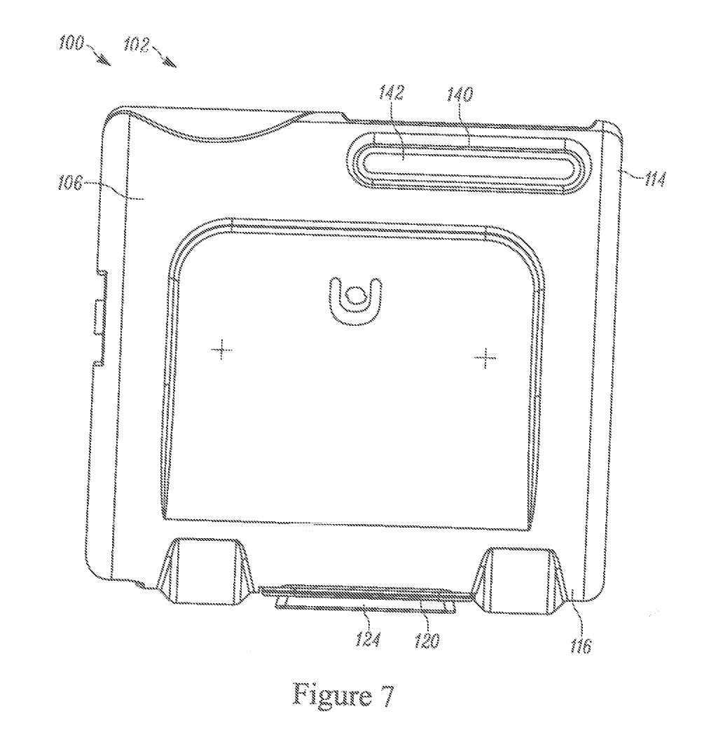

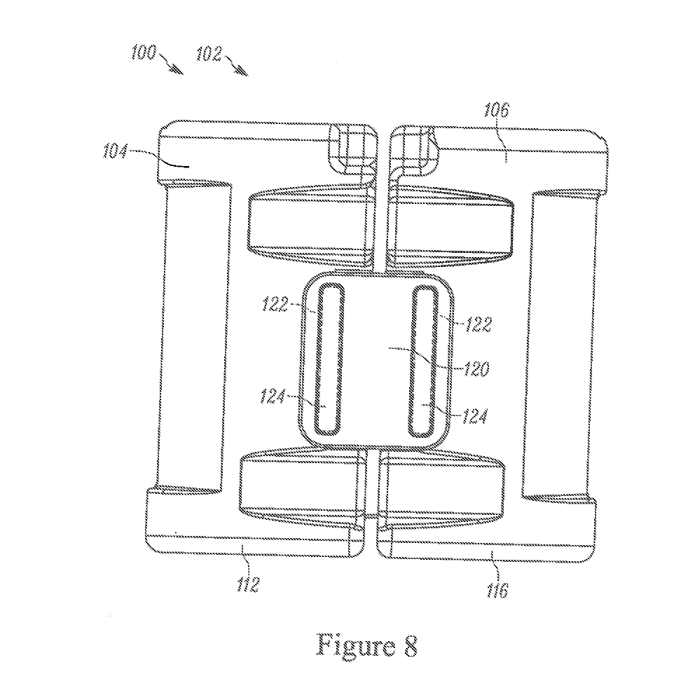

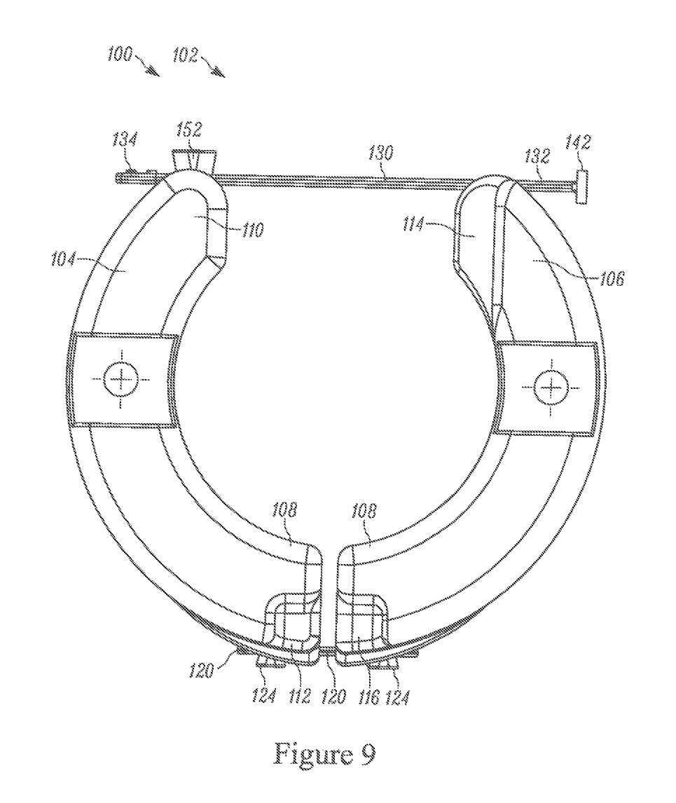

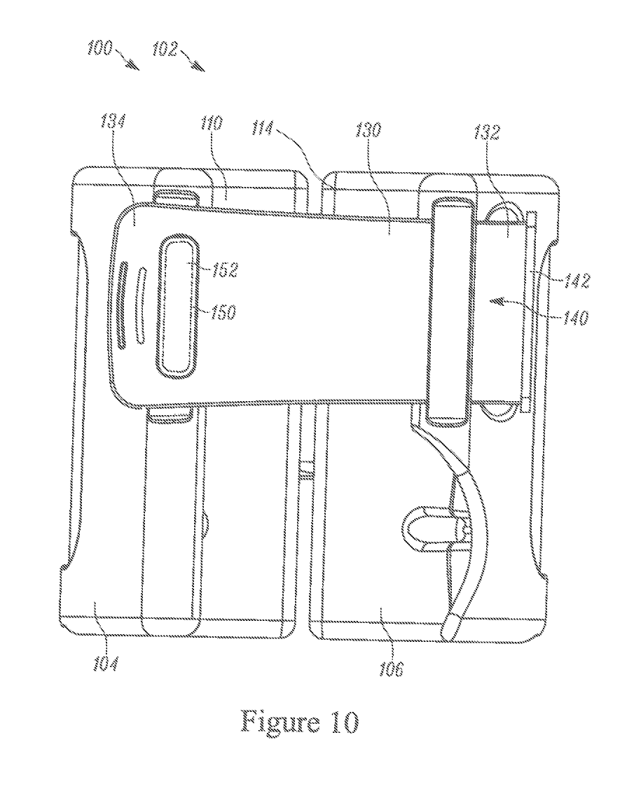

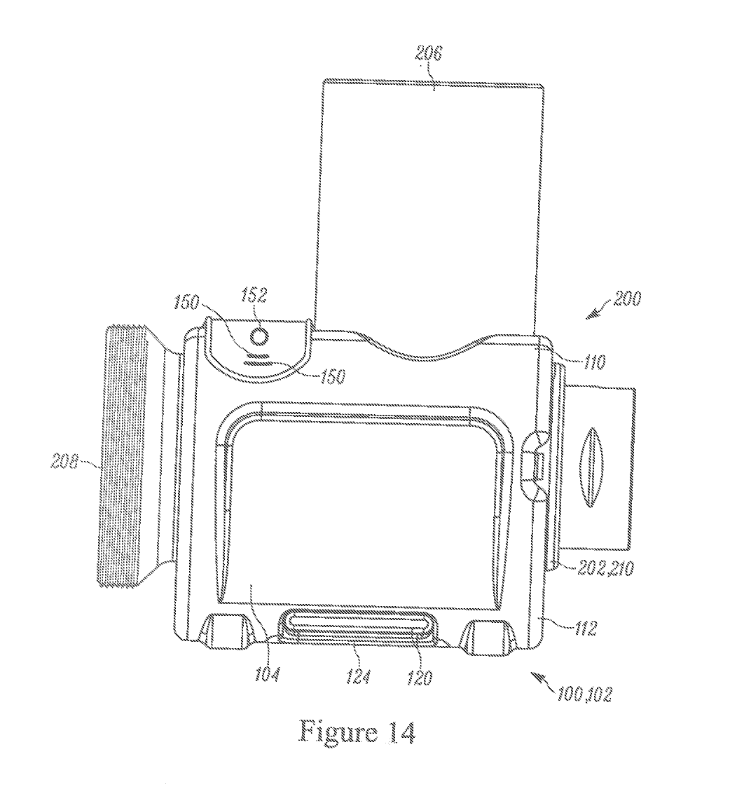

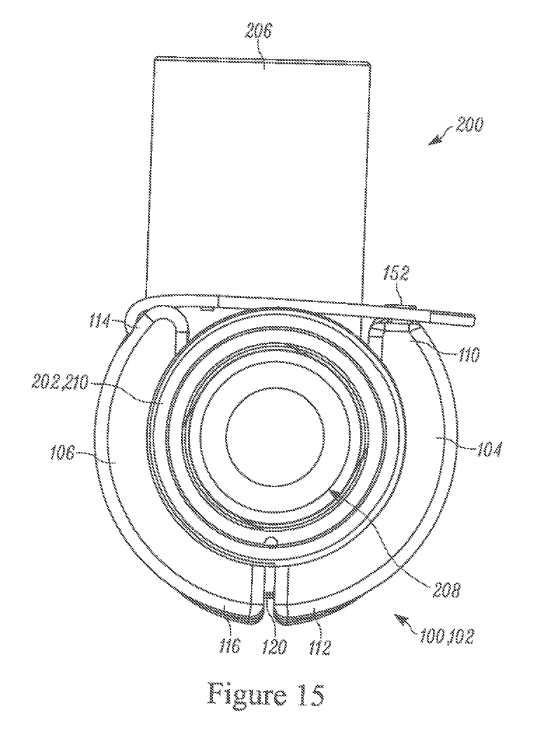

A second embodiment is illustrated in FIGS. 6-15. According to the second embodiment, an apparatus 100 adds a cooling feature to a known food processing apparatus 200 in the form of a conventional meat grinder. The meat grinder 200 includes a grinder head 202 and a power source (not shown, see FIGS. 1-5), such as an electric motor. The electric motor power source could be replaced with a hand crank. The grinder head 202 includes an inlet or chute 206, into which raw meat is fed, and an outlet 208 from which the ground or minced meat is discharged. The grinder head 202 includes a housing 210 that houses typical grinder components, such as an auger/screw conveyor, a rotating knife including mincing blades, and a fixed hole plate or die, These typical components are shown, for example, in U.S. Pat. No. 7,207,510 B2, issued Apr. 24, 2007, the disclosure of which is hereby incorporated by reference in its entirety. A collar (not shown, see FIGS. 1-5) attaches to the housing 210 to contain the grinder components therein. The collar is removable from the housing for cleaning and for replacing/swapping components.

Whole or cubed raw meat is fed into the inlet 206 on top of the grinder head, and the meat is propelled horizontally on the rotating screw conveyor, which can also squash and partially mix the meat as it is propelled. At the end of the screw conveyor, the knife is positioned in front of and adjacent to the fixed hole plate. The screw conveyor forces the meat past the knife and through the plate. The rotating knife blades mince or grind the meat, which is discharged through the holes in the plate and through the outlet 208. The size of the holes in the plate determines the fineness of the ground meat.

According to the second embodiment of the invention, the apparatus 100 provides a cooling feature to the meat grinder 200 that counteracts heating due to friction between internal grinder components. This helps prevent the meat from heating up as it is ground, which can cause the ground meat to stick to the grinder components and inhibit or halt the grinding process. The cooling feature can have a variety of configurations.

In the embodiment illustrated in FIGS. 6-15, the apparatus 100 includes a cooling pack 102. The cooling pack 102 has a generally semi-cylindrical, generally C-shaped configuration that mates with a lower portion of the cylindrical grinder housing 210. More specifically, the cooling pack 102 includes first and second halves 104 and 106 that have cylindrical configurations, each of which covers a portion of the housing 210. Each halve 104, 106 has a curved cylindrical inner surface 108 that mates with the outer surface 230 of the grinder housing 210. Each of the cooling pack halves 104, 106 covers less than 180 degrees of the cylindrical outer surface 230 of the housing 210. In combination, the cooling pack halves 104, 100 can cover greater than 180 degrees of the outer surface 230 of the grinder housing 210. For example, the cooling pack halves 104, 106 can be configured the cooling pack 102 covers about 300 degrees of the outer surface 230 of the housing 210. The cooling pack 102 could be configured to cover the outer surface 230 to different degrees and extents.

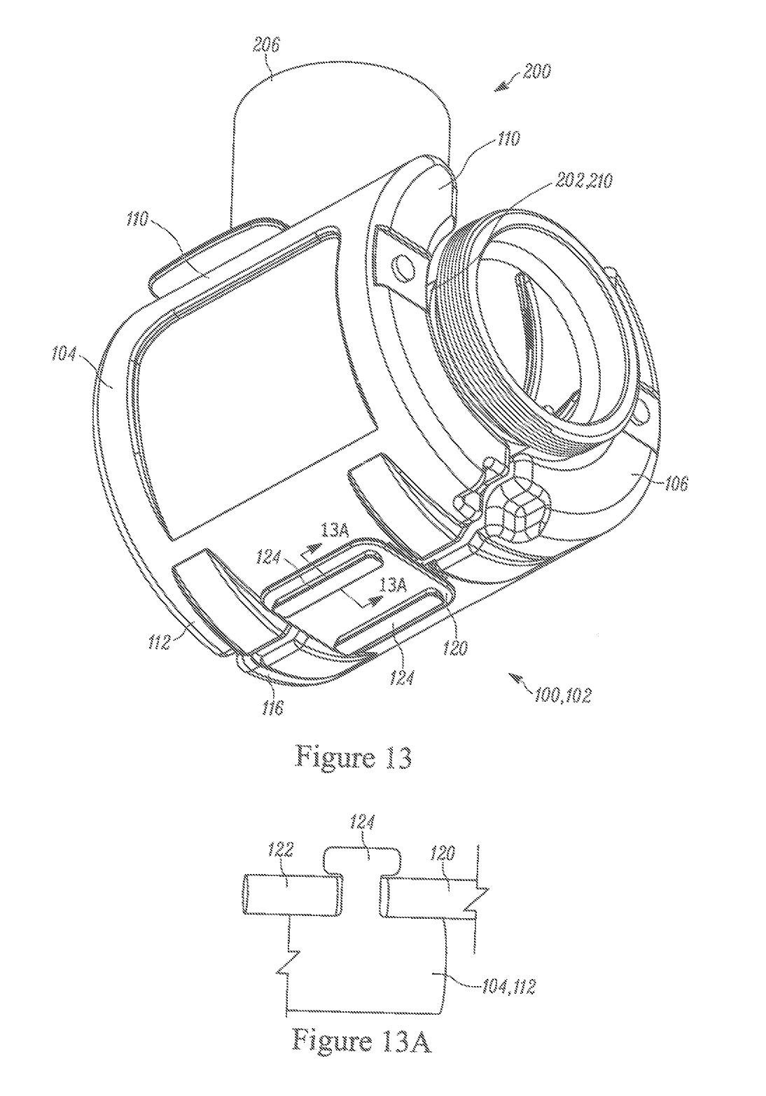

The first cooling pack half 104 includes a first or upper end 110 and a second or lower end 112. The second cooling pack half 106 includes a first or upper end 114 and a second or lower end 116. The apparatus 100 includes a first strap 120 connects the lower ends 112, 116 of the halves 104, 106 such that the ends are positioned. adjacent each other. The first strap 120 can be constructed of an elastomeric material, such as rubber or plastic. In this construction, the first strap 120 includes a pair of elongated openings 122 that mate with respective tabs 124 on each of the tower ends 112, 116. The tabs 124 can be larger than the openings 122 so as to form an interference. The elastomeric first strap 120 can stretch so that the tabs 124 can fit through the openings 122 and will return under their own resilience to their original form to maintain the strap connected to the halves 104, 108 via the interference fit. This is best illustrated in FIG. 13A, The first strap 120 thus can connect the first and second cooling pack halves 104, 106 and also permit the halves to move relative to each, other so that the cooling pack 102 can be fit over/around the housing 210.

The lower ends 112, 116 can be connected in alternative manners. For example, the lower ends 112, 116 can be interconnected by a mechanical hinge or by a hinge that is molded integrally with the cooling pack 102. The manner in which the lower ends 112, 116 of the halves 104, 106 are interconnected is not critical as long as the requisite relative movement of the halves is permitted.

The apparatus 100 also includes a second strap 130 that has a first end 132 connected to the upper end 114 of the second half 106 of the cooling pack 102 and an opposite second end 134 that is releasably connectable with the upper end 110 of the first half 104 of the cooling pack 102. The second strap 130 can be constructed of an elastomeric material, such as rubber or plastic. The connections between the second strap 130 and the cooling pack 102 can have any configuration that permits the pack to be fastened to the housing 210 and released from the housing.

In the embodiment illustrated in FIGS. 6-15, the upper end 114 of the second half 106 of the cooling pack 102 includes an elongated opening 140 through which the first end 132 of the second strap 130 can be passed through. The second strap 130 can be drawn through the opening 140 until the second end 134 reaches the opening. At that point, an elongated, transversely extending stop piece 142 at the second, end 134 of the strap 130 enters the opening 140 and forms an interference with the second half 106 of the cooling pack 102 and thereby connects the second strap 130 to the second half.

The second end 134 of the second strap 130 includes one or more elongated openings 150 that are connectable with a tab 152 on the upper end 110 of the first half 104 of the cooling pack 102. The tab 152 and opening 150 can cooperate to connect the second end 134 of the second strap 130 to the first half 104 in a manner similar or identical to that shown in FIG. 13A. The second strap 130 can thus be connected to the first half 104 and disconnected from the second half with ease and repeatability.

The connections of the second strap 130 can have alternative configurations. For example, the first end 132 of the strap 130 can be connected to the second half 106 via a mechanical fastener, such as a rivet. The second end 134 of the strap 130 can be connected to the first half 104 via a mechanical fastener, such as a buckle.

The cooling pack 102, i.e., the cooling pack halves 104, 106, can be filled with a coolant, such a liquid/gel-type substance commonly found in freezer chilled cooling packs. The cooling pack 102 is thus freezable and re-freezable. These gel in the gel packs are primarily water-based and include a gel-forming substance, such as hydroxyethyl cellulose or a vinyl-coated silica gel. Other materials can be added to prevent bacterial growth. Advantageously, the substance in such gel packs can formulated to have a freezing point below that of water (32° F.) and therefore, can enhance the cooling of the grinder head 202. The cooling pack 102 can have a variety of constructions. For example, the cooling pack 102 can be formed of plastic, metal, or a combination of plastic and metal.

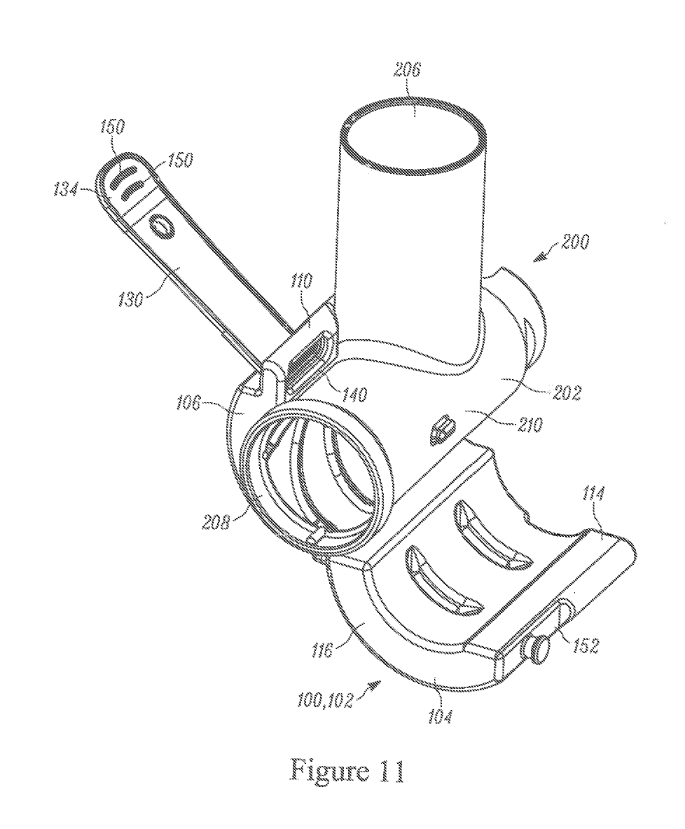

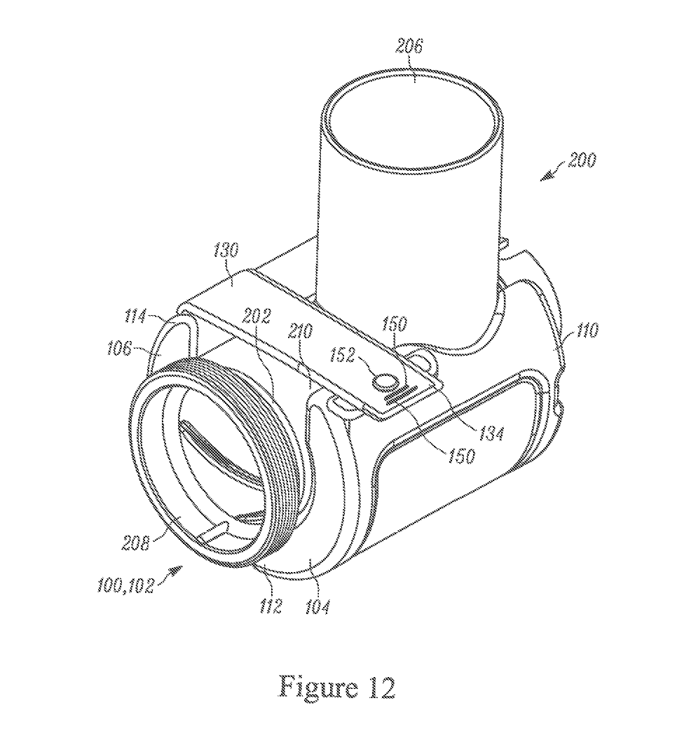

To install the apparatus 100 on the grinder head 202, the apparatus is placed in an open condition as shown in FIG. 11. The first strap 120 maintains the connection between the lower ends 112, 116 of the cooling pack halves 104, 106 and permits relative movement between the halves so that they can be maneuvered to the position shown in FIG. 11. The upper ends 110, 114 of the cooling pack halves 104, 106 can then be brought together so that they extend around the grinder head 202 and the inner surfaces 108 of the cooling pack halves engage and mate with the outer surface 230 of the grinder head housing 210. At this point, the second end 134 of the second strap 130 can be connected to the first half 104 by placing the opening 150 over the tab 152 (see FIG. 12).

Advantageously, the removable cooling pack 102 allows for the use of multiple cooling packs in an interchangeable fashion. When the cooling packs 102 heat up during use and lose their effectiveness, they can be swapped with frozen standby packs, thus eliminating the need to halt the grinding process for a prolonged period. During use, the cooling pack 102 helps to maintain the grinder head 202 at a low temperature. For example, the coolant in the packs 102 can maintain the grinder head 202 at about 40° F. or less. The advantage of a coolant/gel-filled cooling pack 102 is that the eel can be formulated for cooling below 32° F. The elastomeric construction of the straps 120, 130 can urge the cooling pack 102 against the housing 210 to help ensure effective heat transfer, i.e., cooling, of the grinder head 202.

While aspects of the present invention have been particularly shown and described with reference to the preferred embodiment above, it will be understood by those of ordinary skill in the art that various additional embodiments may be contemplated without departing from the spirit and scope of the present invention. For example, the tab/slot configuration used to connect the cooling pack to the housing could be replaced with an alternative connection without departing from the spirit and scope of the invention. Other aspects, objects, and advantages of the present invention can be obtained from a study of the drawings, the disclosure, and the appended claims.

Having described the invention, we claim:

1. An apparatus for cooling a grinder head, comprising:
a cooling pack adapted to be connected to an outer surface of a housing of the grinder head to cool the grinder head housing.

2. The apparatus recited in claim 1, wherein the cooling pack has a cylindrical configuration that mates with the cylindrical outer surface of the grinder head housing.

3. The apparatus recited in claim 1, wherein the cooling pack extends circumferentially greater than 180 degrees around the grinder head housing.

4. The apparatus recited in claim 1, wherein the cooling pack has a freezable and re-freezable construction.

5. The apparatus recited in claim 1, wherein the cooling pack comprises a first cooling pack half that has a cylindrical inner surface, and a second cooling pack half that has a cylindrical inner surface, the first and second cooling packs being connected to each other.

6. The apparatus recited in claim 5, further comprising:
a first strap that connects a first end of the first cooling pack half to a first end of the second cooling pack half, the first strap being constructed and arranged to permit the first and second. cooling pack halves to move relative to each other; and
a second strap that connects a second end of the first cooling pack half to a second end of the second cooling pack half, the second strap being releasable connectable with at least one of the first and second cooling pack halves.

7. The apparatus recited in claim 6, wherein the first strap permits the first and second cooling pack halves to move to an open condition in which the grinder head housing can be positioned between the halves, and wherein the second strap when connected to both cooling pack halves draws the halves together to connect the cooling pack to the grinder head housing.

8. The apparatus recited in claim 7, wherein at least one of the first and second straps has an elastomeric construction that applies a force to the cooling pack halves that draws the halves into mating engagement with the outer surface of the grinder head housing.

9. The apparatus recited in claim 6, wherein at least one of the first and second straps connects with at least one of the first and second cooling pack halves via an opening in the strap that deforms elastically to receive a tab on the cooling pack, the opening forming an interference with the tab that connects the strap to the cooling pack half.

10. The apparatus recited in claim 1, wherein the first and second cooling pack halves comprise gel-filled cooling packs.

11. A grinder head housing cooling apparatus comprising first and second cooling pack halves filled with a freezable and re-freezable substance, and at least one connector for connecting the cooling pack halves to each other and to the outer surface of the grinder head housing to cool the grinder head housing through thermal heat transfer.

12. The apparatus recited in claim 11, wherein each of the cooling pack halves has a cylindrical configuration that mates with the cylindrical outer surface of the grinder head housing.

13. The apparatus recited in claim 11, wherein each cooling pack half extends circumferentially less than 180 degrees around the grinder head housing, and wherein the cooling pack halves together extend circumferentially greater than 180 degrees around the grinder head housing.

14. The apparatus recited in claim 11, wherein the first cooling pack half has a cylindrical inner surface, and the second cooling pack half has a cylindrical inner surface.

15. The apparatus recited in claim 11, further comprising:
a first strap that connects a first end of the first cooling pack half to a first end of the second cooling pack half, the first strap being constructed and arranged to permit the first and second cooling pack halves to move relative to each other; and
a second strap that connects a second end of the first cooling pack half to a second end of the second cooling pack half, the second strap being releasable connectable with at least one of the first and second cooling pack halves.

16. The apparatus recited in claim 15, wherein the first strap permits the first and second cooling pack halves to move to an open condition in which the grinder head housing can be positioned between the halves, and wherein the second strap when connected to both cooling pack halves draws the halves together to connect the cooling pack to the grinder head housing.

17. The apparatus recited in claim 15, wherein at least one of the first and second straps has an elastomeric construction that applies a force to the cooling pack halves that draws the halves into mating engagement with the outer surface of the grinder head housing.

18. The apparatus recited in claim 15, wherein at least one of the first and second straps connects with at least one of the first and second cooling pack halves via an opening in the strap that deforms elastically to receive a tab on the cooling pack, the opening forming an interference with the tab that connects the strap to the cooling pack half.

19. The apparatus recited in claim 11, wherein the first and second cooling pack halves comprise gel-filled cooling packs.
